(19) United States
(12) Patent Application Publication
(10) Pub. No.: US 2024/0201335 A1
(43) Pub. Date: Jun. 20, 2024

(54) CONCEALED CORNER LASER RADAR INTEGRATION DEVICE, AND VEHICLE HAVING SAME

(71) Applicant: Wuhan Lotus Cars Co., Ltd., Wuhan (CN)

(72) Inventors: Hongshuang LI, Wuhan (CN); Shaoyan LIU, Wuhan (CN); Bo LI, Wuhan (CN); Yongqing ZHU, Wuhan (CN); Yanhong WANG, Wuhan (CN); Shichao HE, Wuhan (CN); Xiange LONG, Wuhan (CN); Qunxiong WEI, Wuhan (CN)

(73) Assignee: Wuhan Lotus Cars Co., Ltd., Wuhan, HB (CN)

(21) Appl. No.: 18/554,469

(22) PCT Filed: Mar. 24, 2022
(86) PCT No.: PCT/CN2022/082890

§ 371 Date: Oct. 8, 2023

(30) Foreign Application Priority Data
May 12, 2021 (CN) 202121029038.3

(51) Int. Cl. G01S 7/481; G01S 17/931

(52) U.S. Cl. CPC G01S 7/4813; G01S 17/931

(57) ABSTRACT

A concealed integrated device of corner laser radars comprising a cover plate, a fixed support, a lifting structure, an ejection structure, laser radars and a controller, wherein the cover plate is located on a fender of a vehicle body and matches an opening in the fender in terms of size; the fixed support, the lifting structure, the ejection structure, the laser radars and the controller are all located inside the fender; the lifting structure is arranged on the fixed support and is connected to the cover plate; the laser radars are arranged on the ejection structure; and the ejection structure is arranged on the fixed support.

### CROSS REFERENCE TO RELATED APPLICATIONS

This patent application claims priority of Chinese patent application filed on May 12, 2021, with an application number 202121029038.3, an applicant WUHAN LOTUS CARS CO., LTD., an invention title “CONCEALED INTEGRATED DEVICE OF CORNER LASER RADARS, AND VEHICLE HAVING SAME”; The entire content of the above application is incorporated into the present application by reference.

### TECHNICAL FIELD

The present invention relates to the technical field of laser radars, and in particular to a concealed corner laser radar integration device and a vehicle having same.

### BACKGROUND

Laser radars are important sensors for achieving high-level intelligent driving and autonomous driving. Using laser radars can compensate for the shortcomings of cameras and millimeter wave radars: compared with cameras, they can build more realistic 3D environments without relying on ambient light, and have higher resolutions and more accurate object recognition ability compared with millimeter wave radars.

Currently, laser radars are limited by volumes of lasers and areas of laser emitting (receiving) mirrors, their overall sizes are larger than that of cameras and millimeter wave radars, making it difficult to arrange them on entire vehicles and susceptible to limitations in layout and styling.

Horizontal view field angles (view field ranges for sensing point cloud information) of laser radars are generally around 120 degrees. In order to perceive a 360 degree horizontal field of view, the prior art usually requires 4-5 laser radars for view field splicing. Corner laser radars, as the name suggests, are generally mounted at corners, or sides, or lower positions at both sides of front and rear bumpers, of a vehicle body, to be responsible for sensing lateral field of view and serve as a supplement to the fields of view of forward and backward laser radars, thereby achieving a 360 degree horizontal field of view of laser radars.

### SUMMARY OF THE DISCLOSURE

### Technical Problems

There are some defects in the technical solutions in the prior art.
1. A device that fixes a laser radar to a vehicle body is relatively simple in appearance and has a significant impact on the design, it is unable to reflect technological sense of autonomous driving usage scenarios and heat dissipation issues of the laser radar will be caused.
2. A horizontal view field angle of a laser radar is generally around 120 degrees, and the arrangement plan of 4-5 laser radars will cause waste of the view field angle. Moreover, laser radars are expensive, with a single cost usually greater than 5000 RMB, such an arrangement manner is not conducive to the overall cost of a vehicle.
3. Regarding the arrangement at lower positions of sides and corners of front and rear bumpers, these positions are collision prone areas; combined with the characteristic of the high cost of laser radars, such an arrangement manner is not conducive to the economy of maintenance for an entire vehicle.
4. Laser radars adopt a fixed scheme, with lenses exposed to the outside; while the laser radars' lenses are mostly made of PC or glass material, with hardnesses less than that of sand and gravel, and a higher risk of scratches during use.

### Technical Solutions

In view of this, the present invention provides a concealed corner laser radar integration device and a vehicle having same, which reduce the number of corner laser radars from 4-5 to 2, such that a cost advantage exists. The arrangement is at positions on a front fender, such that the risk of collision is reduced compared with that of the arrangement at positions of front and rear bumpers. A concealed cleaning system is integrated so as to improve users' experience, at the same time, the requirement for beauty of a roof design is met, and a sense of technology of a vehicle is enhanced.

The present invention provides a concealed corner laser radar integration device comprises at least a cover plate, a fixed support, a lifting structure, an ejection structure, a laser radar, and a controller; wherein the cover plate is located on a fender of a vehicle body and matches an opening of the fender in terms of size; the fixed support, the lifting structure, the ejection structure, the laser radar, and the controller are all located inside the fender; the lifting structure is arranged on the fixed support and is connected to the cover plate, and can drive the cover plate to move upward and downward under control of the controller; the laser radar is arranged on the ejection structure; the ejection structure is arranged on the fixed support and can move outward relative to the fixing support under control of the controller to push the laser radar out from the inside of the fender.

Furthermore, the fixing support comprises first fixing plates and a connection plate, the first fixing plates are located at two sides of the connection plate, and the first fixing plates are fixed to a front body longitudinal beam at an inner side of the fender through bolts.

Furthermore, the lifting structure comprises at least a first motor, a transmission shaft, a first gear, a screw rod, a lifting rod, a sliding rail, a fixing block, and a second fixing plate; the sliding rail inclines upward and inward from a lower part of the fixing support, a bottom end thereof is fixed to the connection plate, and the fixing block is arranged at a top end thereof, the screw rod passes through the fixing block and is arranged parallel to the sliding rail, the lifting rod is arranged at a lower end thereof, the first gear is fixed at a top part of the screw rod, and the lifting rod is connected to the cover plate; the first motor and the controller are fixed on the second fixing plate, the first motor is connected to the transmission shaft, and the transmission shaft meshes with the first gear.

Furthermore, the fixing block is connected to the screw rod by screw thread; the lifting rod comprises a first lifting rod and a second lifting rod, the first lifting rod is sleeved on and connected by screw thread to a lower end of the screw rod, and the second lifting rod has one end connected to the first lifting rod and another end fixedly connected to a bottom end of a side of the cover plate.

Furthermore, a cleaning structure is included, and the cleaning structure is arranged on the ejection structure together with the laser radar.

Furthermore, the cleaning structure comprises at least a fixing bracket, an electromagnetic valve, a nozzle, a connection part, and a water inlet; the electromagnetic valve has one end connected to the connection part and another end connected to the water inlet, the water inlet is connected to a pipeline which is connected to a waterway of an entire vehicle; the nozzle is connected to the connection part and has a telescoping function.

Furthermore, the ejection structure comprises at least a second motor, a decelerator, a second gear, a movement plate, a movement rod, and a sealing strip; an output shaft of the second motor is connected to the decelerator, the decelerator is connected to the second gear; the movement plate is placed on the connection plate of the fixing support and forms a preset angle with an outside edge of the connection plate; the laser radar and the cleaning structure are mounted on the movement plate, the sealing strip is mounted at a front side of the movement plate.

Furthermore, the movement plate is provided with a hole, the movement rod comprises a first movement rod and second movement rod, the second movement rod is connected to the first movement rod by a preset angle; a lower part of an end of the first movement rod is provided with a convex column, the convex column is clamped with the hole; the second movement rod is arc-shaped, an outside section thereof is provided with teeth, the teeth mesh with the second gear.

Furthermore, one side of the laser radar is fixed with a mirror, and the other side is equipped with a second wire harness, the second wire harness is connected to an autonomous driving domain controller or an advanced auxiliary driving domain controller.

The present invention further provides a vehicle, the vehicle comprises the aforementioned concealed corner laser radar integration device.

### Advantageous Effects

The present invention provides a concealed corner laser radar integration device, which adopts a concealed scheme. The laser radars can retract into a vehicle body in a standby state to avoid generating effect on an appearance design and reduce the risk of being scratched by sand and gravel; when an autonomous driving function is activated, the laser radars are rotated out and reach working positions to enhance a sence of technology. The concealed cleaning structure is integrated, cleanliness of the mirrors of the laser radars are always maintained during autonomous driving, the frequency of manual cleaning is greatly reduced, and users' experience is improved. The number of the corner laser radars is reduced from 4-5 to 2, such that a cost advantage exists. The arrangement is at positions on a front fender, the risk of collision is reduced compared with that of positions of front and rear bumpers.

### BRIEF DESCRIPTION OF THE DRAWINGS

FIG. 1 is a schematic view of mounting positions of a concealed corner laser radar integration device of the present invention on a vehicle body.

FIG. 2 is an overall structural schematic view of a concealed corner laser radar integration device of the present invention.

FIG. 3 is a structural schematic view of a lifting structure in the present invention.

FIG. 4 is a schematic view of a cleaning structure in the present invention.

FIG. 5 is a structural schematic view of a fixing bracket in the present invention.

FIG. 6 is a schematic view of an ejection structure in the present invention.

FIG. 7 is a top view of laser radars in a turning-on state in the present invention.

### DETAILED DESCRIPTION

Specific implementations of the present invention are further described in detail below in combination with the accompany drawings and embodiments. The following embodiments are used to illustrate the present invention, but are not used to limit the scope of the present invention.

In the description of the present invention, it should be noted that orientations or position relationships indicated in this description are based on orientations or position relationships shown in the accompanying drawings, and are only for the convenience of describing the present invention and simplifying the description, rather than indicating or implying that devices or elements referred to must have specific orientations or be constructed and operated in specific orientations, and therefore cannot be understood as any limitation to the present invention.

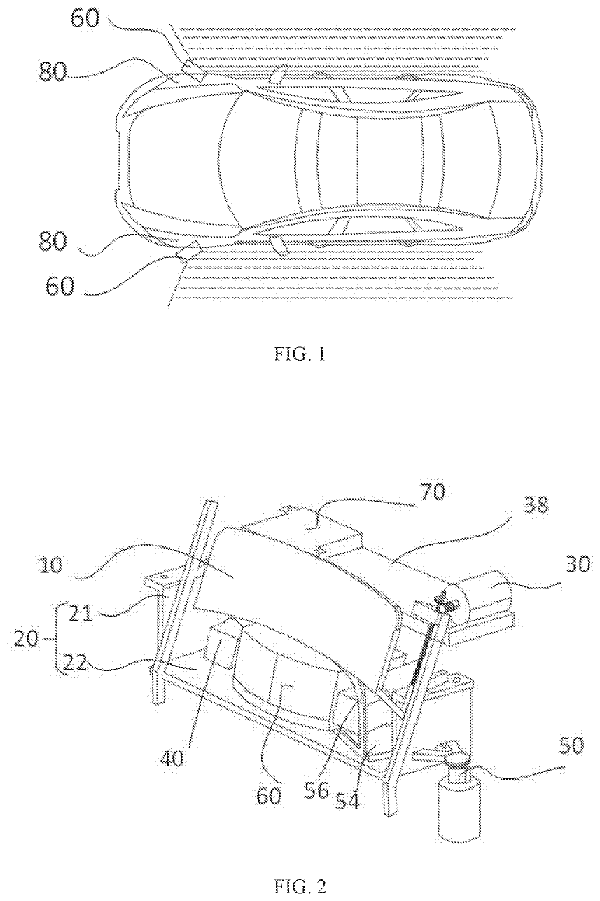

Referring to FIG. 1 and FIG. 2, a c concealed corner laser radar integration device provided by the present invention includes at least a cover plate 10, a fixed support 20, a lifting structure 30, a cleaning structure 40, an ejection structure 50, a laser radar 60, and a controller 70. The cover plate 10 is located on a fender 80 of a vehicle body and matches an opening of the fender 80 in terms of size. The fixed support 20, the lifting structure 30, the cleaning structure 40, the ejection structure 50, the laser radar 60, and the controller 70 are all located inside the fender 80. The lifting structure 30 is arranged on the fixed support 20 and is connected to the cover plate 10, and can drive the cover plate 10 to move upward and downward under control of the controller 70; the laser radar 60 is arranged on the ejection structure 50; the ejection structure 50 is arranged on the fixed support 20 and can move outward relative to the fixing support 20 under control of the controller 70 to push the laser radar 60 out from the inside of the fender 80. The cleaning structure 40 is arranged on the ejection structure 50 together with the laser radar 60, the controller 70 is located above the laser radar 60 and is connected to an autonomous driving domain controller or an advanced auxiliary driving domain controller through a first wire harness.

Specifically, referring to FIG. 2 again, the fixing support 20 includes first fixing plates 21 and a connection plate 22, the first fixing plates 21 are located at two sides of the connection plate 22, and the first fixing plates 21 are fixed to a front body longitudinal beam at an inner side of the fender 80 through bolts

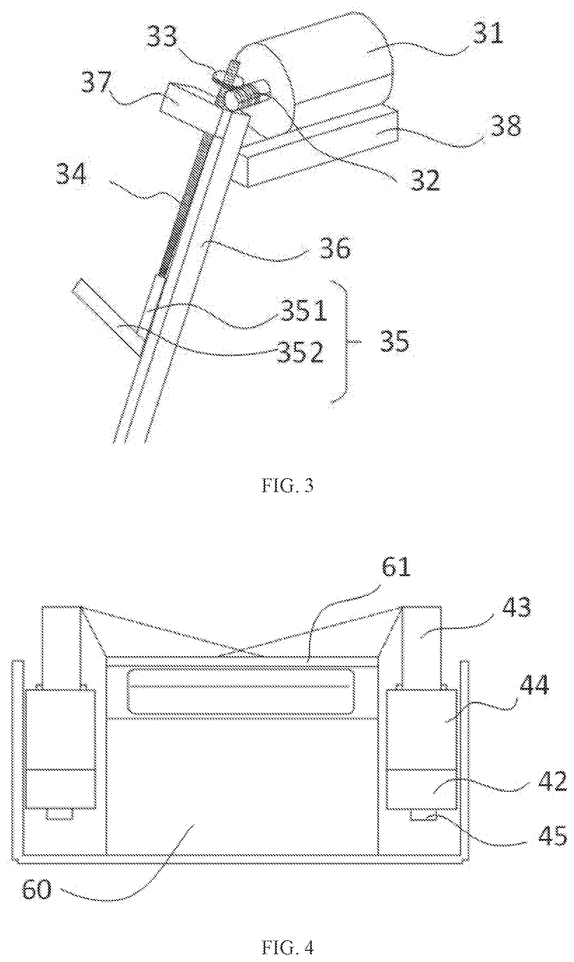

Specifically, referring to FIG. 2 and FIG. 3, the lifting structure 30 includes at least a first motor 31, a transmission shaft 32, a first gear 33, a screw rod 34, a lifting rod 35, a sliding rail 36, a fixing block 37, and a second fixing plate 38.

Furthermore, the sliding rail 36 extends inclinedly upward and inward from a lower part of the fixing support 20, a bottom end thereof is fixed to the connection plate 22, and the fixing block 37 is arranged at a top end thereof. The screw rod 34 passes through the fixing block 37 and is arranged parallel to the sliding rail 36, the fixing block 37 is connected to the screw rod 34 by screw thread, and the screw rod 34 has a lower end being provided with the lifting rod 35 and a top end fixed with the first gear 33. The lifting rod 35 includes a first lifting rod 351 and a second lifting rod 352, the first lifting rod 351 is sleeved on and connected by screw thread to the lower end of the screw rod 34, and the second lifting rod 352 has one end connected to the first lifting rod 351 by a preset angle and another end fixedly connected to a bottom end of a side of the cover plate 10. The first motor 31 and the controller 70 are fixed on the second fixing plate 38, the motor 31 is connected to the transmission shaft 32, and the transmission shaft 32 meshes with the first gear 33. When the first motor 31 rotates forward, it drives the transmission shaft 32 to rotate, the transmission shaft 32 drives the first gear 33 to rotate, and the first gear 33 drives the screw rod 34 to rotate. The first lifting rod 351 performs upward movement relative to the screw rod 34, and drives the second lifting rod 352 and the cover plate 10 to perform upward movement; the cover plate 10 is opened, the laser radar 60 and the cleaning structure 40 are ejected out of the fender 80 under drive of the ejection structure 50. When the first motor 31 rotates reversely, the movement process is opposite to the forward rotation, the cover plate 10 undergoes a downward motion, and the laser radar 60 and the cleaning structure 40 are retracted into the interior of the fender 80 under drive of the ejection structure 50.

It should be noted that the lifting structure 30 is not limited to the lifting structure 30 described in this embodiment. Any device with the lifting function can replace the lifting structure 30 described in this embodiment. Specific structures of lifting structures in the prior art will not be repeated in the present invention

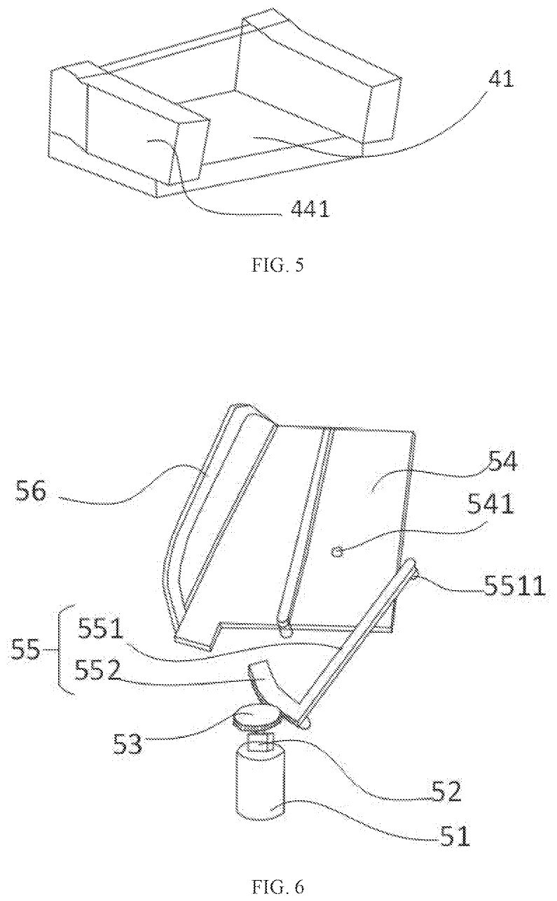

Specifically, referring to FIG. 2, FIG. 4, and FIG. 5, the cleaning structure 40 includes at least a fixing bracket 41, an electromagnetic valve 42, a nozzle 43, a connection part 44, and a water inlet 45; the laser radar 60 is arranged on the fixing bracket 41, and two side of the fixing bracket 41 are respectively provided with a set of combination structure 411 including an electromagnetic valve 42, a nozzle 43, a connection part 44, and a water inlet 45. Specifically, the electromagnetic valve 42 has one end connected to the connection part 44 and another end connected to the water inlet 45 to control the water inlet 45 to be turned on and off, the water inlet 45 is connected to a pipeline which is connected to a waterway of an entire vehicle. The nozzle 43 is connected to the connection part 44, and the nozzle 43 has a telescoping function. It retracts back to the interior of the connection part 44 when not being used and extends out of the connection part 44 by action of water pressure during use.

It should be noted that the nozzle 43 not only can be a telescopic structure that can extend out of or retract into the connection part 44, but also can be a fixed structure that is directly fixed to the connection part 44 and does not move relative to the connection part 44. In this embodiment, the nozzle 43 is in a telescopic style.

Specifically, referring to FIG. 2 and FIG. 6, the ejection structure 50 includes at least a second motor 51, a decelerator 52, a second gear 53, a movement plate 54, a movement rod 55, and a sealing strip 56.

Furthermore, the second motor 51 is fixed in the interior of the fender 80, its output shaft is connected to the decelerator 52, and the decelerator 52 is connected to the second gear 53. The movement plate 54 is placed on the connection plate 22 of the fixing support 20 and can swing inwards and outwards relative to the fixing support 20. When the movement plate 54 is rotated out relative to the fixing support 20, the movement plate 54 forms a preset angle with an outside edge support of the connection plate 22, in this embodiment, it is at a 30 degree angle. The laser radar 60 and the cleaning structure 40 are mounted on the movement plate 54, the movement plate 54 is further provided with a hole 541. The movement rod 55 includes a first movement rod 551 and a second movement rod 552, the first movement rod 551 passes through a slot at the first fixing plate 21 close thereto, and can swing relative to the first fixing plate 21. A lower part of an end of the first movement rod 551 is provided with a convex column 5511, the convex column 5511 is clamped with the hole 541 of the movement plate 54; the second movement rod 552 is arc-shaped, an outside section thereof is provided with teeth, which mesh with the second gear 53. The second movement rod 552 is connected to the first movement rod 551 by a preset angle, the sealing strip 56 can be mounted at a front side of the movement plate 54, and can also be fixed around an inner opening of the fender 80; in this embodiment, the sealing strip 56 is mounted at the front side of the movement plate 54. When the second motor 51 rotates forward, under drive of the second motor 51 and the decelerator 52, the second gear 53 rotates to drive the second movement rod 552 to rotate, and further drives the first movement rod 551 to rotate. The movement plate 54 connected to the first movement rod 551, the laser radar 60, and the cleaning structure 40 are rotated out and ejected to the exterior of the fender 80. At this time, the sealing strip 56 fits around the opening in the fender 80, the sealing strip 56 has a waterproof function, which can prevent sewage from splashing into the interior of the fender 80 when the cleaning structure 40 is working. When the second motor 51 rotates reversely, the movement plate 54, the laser radar 60, and the cleaning structure 40 are retracted into the interior of the fender 80.

It should be noted that the ejection structure 50 is not limited to the ejection structure 30 described in this embodiment. Any device with the ejection function can replace the ejection structure 50 described in this embodiment. Specific structures of ejection structures in the prior art will not be repeated in the present invention.

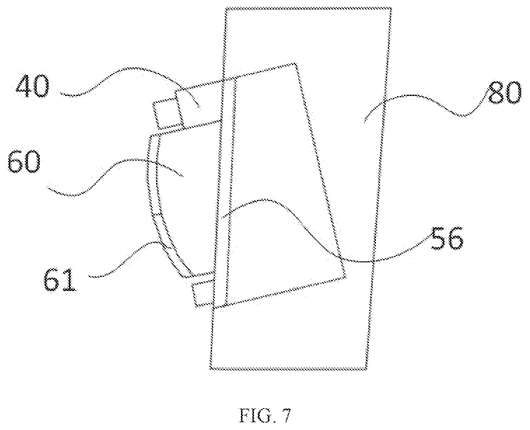

Specifically, referring to FIG. 4 and FIG. 7, a working side of the laser radar 60 is fixed with a mirror 61, and the other side is connected with a second wire harness, the second wire harness is connected to an autonomous driving or advanced auxiliary driving domain controller. When the laser radar 60 detects that the mirror 61 is affected by dirt, the second wiring harness can transmit a signal to the autonomous driving or advanced auxiliary driving domain controller, the autonomous driving or advanced auxiliary driving domain controller sends a cleaning signal to the electromagnetic valve 42. The electromagnetic valve 42 is opened, and the nozzle 43 sprays water onto the mirror 61 to perform cleaning work. The nozzle 43 in FIG. 4 is a state diagram when extended, and the dashed line represents the water spraying range, that is, the water sprayed from the nozzles 43 on both sides can cover the entire mirror 61.

It should be noted that, referring to FIG. 1 and FIG. 7, the concealed corner laser radar integration device provided by the present invention is mounted on the fenders 80 on both sides of a front end of a vehicle body, with a working angle forming an included angle of 30 degrees with a forward direction of the vehicle body, and can perceive a horizontal field of view of 120 degrees.

The working principle of the concealed corner laser radar integration device provided by the present invention is as follows: when a user has a driving need, the autonomous driving or advanced auxiliary driving domain controller sends a turning-on signal for the integrated device of corner laser radars, the controller 70 in the integrated device first drives the first motor 31 to rotate forwards. The lifting structure 30 starts to work, and under rotation of the transmission shaft 32, the first gear 33, and the screw rod 34, the first lifting rod 351 and the second lifting rod 352 drives the cover plate 10 to ascend and open the concealing opening. Afterwards, the controller 70 drives the second motor 51 to rotate forwards, the ejection structure 50 starts to work; under drive of the decelerator 52 and the second gear 53, the second movement rod 552 generates rotation, the first movement rod 551 drives the movement plate 54 to move, the laser radar 60 and the cleaning structure 40 are ejected to the exterior of the fender 80 and form an angle of 30 degrees with a forward direction of a vehicle body, the laser radar 60 starts to work. When the laser radar 60 detects that the mirror 61 is affected by dirt, it transmits a dirt signal to the autonomous driving or advanced auxiliary driving domain controller, the autonomous driving or advanced auxiliary driving domain controller sends a cleaning signal to the controller 70 in the integrated device, and the autonomous driving or advanced auxiliary driving domain controller drives a cleaning pump to pressurize a waterway; after a delay for a period of time, the controller 70 in the integrated device drives the cleaning structure 40 to work, the electromagnetic valve 42 is opened, and the nozzle 43 sprays water to clean the mirror 61 of the laser radar 60; when cleaning ends, the electromagnetic valve 42 is closed. When exiting the driving function, the autonomous driving or advanced auxiliary driving domain controller sends a turning-off signal for the integrated device of corner laser radars, the controller 70 in the integrated device drives the first motor 31 and the second motor 51 to rotate reversely, the integrated device of corner laser radars is turned off and concealed into the fender 80.

From the above description, it can be known that the concealed corner laser radar integration device provided by the present invention has the following advantages that: by adopting the concealed scheme, the laser radars can retract into the vehicle body in a standby state to avoid generating effect on an appearance design and reduce the risk of being scratched by sand and gravel; when an autonomous driving function is activated, the laser radars are rotated out and reach working positions to enhance a sence of technology. The concealed cleaning structure is integrated, cleanliness of the mirrors of the laser radars are always maintained during autonomous driving, the frequency of manual cleaning is greatly reduced, and users' experience is improved. The number of the corner laser radars is reduced from 4-5 to 2, such that a cost advantage exists. The arrangement is at positions on the front fender, the risk of collision is reduced compared with that of positions of front and rear bumpers.

The present invention further provides a vehicle, which includes the above-described concealed corner laser radar integration device. Other technical features of the vehicle can refer to the prior art and are not repeated here.

The above described are only specific implementations of the present invention, however, the protection scope of the present invention is not limited here. Any change or replacement that can be easily thought by technical personnel familiar with the technical field within the technical field disclosed by the present invention should be covered by the protection scope of the present invention. Therefore, the protection scope of the present invention should be based on the protection scope of the claims.

1. A concealed corner laser radar integration device comprising a cover plate, a fixed support, a lifting structure, an ejection structure, a laser radar, and a controller; wherein the cover plate is configured to be located on a fender of a vehicle body and match an opening of the fender in terms of size; the fixed support, the lifting structure, the ejection structure the laser radar, and the controller are all configured to be located inside the fender; the lifting structure is arranged on the fixed support and is connected to the cover plate, and configured to be drive the cover plate to move upward and downward under control of the controller; the laser radar is arranged on the ejection structure; the ejection structure is arranged on the fixed support and configured to be move outward relative to the fixing support under control of the controller to push the laser radar out from the inside of the fender.

2. The concealed corner laser radar integration device according to claim 1, wherein the fixing support comprises first fixing plates and a connection plate, the first fixing plates are located at two sides of the connection plate, and the first fixing plates are configured to be fixed to a front body longitudinal beam at an inner side of the fender through bolts.

3. The concealed corner laser radar integration device according to claim 2, wherein the lifting structure comprises a first motor, a transmission shaft, a first gear, a screw rod, a lifting rod, a sliding rail, a fixing block, and a second fixing plate; the sliding rail inclines upward and inward from a lower part of the fixing support, a bottom end of the sliding rail is fixed to the connection plate, and the fixing block is arranged at a top end of the sliding rail; the screw rod passes through the fixing block and is arranged parallel to the sliding rail, the lifting rod is arranged at a lower end of the screw rod, the first gear is fixed at a top part of the screw rod, and the lifting rod is connected to the cover plate; the first motor and the controller are fixed on the second fixing plate, the first motor is connected to the transmission shaft, and the transmission shaft meshes with the first gear.

4. The concealed corner laser radar integration device according to claim 3, wherein the fixing block is connected to the screw rod by screw thread; the lifting rod comprises a first lifting rod and a second lifting rod, the first lifting rod is sleeved on and connected by screw thread to a lower end of the screw rod, and the second lifting rod has one end connected to the first lifting rod and another end fixedly connected to a bottom end of a side of the cover plate.

5. The concealed corner laser radar integration device according to claim 1, further comprising a cleaning structure, wherein the cleaning structure is arranged on the ejection structure together with the laser radar.

6. The concealed corner laser radar integration device according to claim 5, wherein the cleaning structure comprises a fixing bracket, an electromagnetic valve, a nozzle, a connection part, and a water inlet; the electromagnetic valve has one end connected to the connection part and another end connected to the water inlet, the water inlet is configured to be connected to a pipeline which is connected to a waterway of an entire vehicle; the nozzle is connected to the connection part and has a telescoping function.

7. The concealed corner laser radar integration device according to claim 2, wherein the ejection structure comprises a second motor, a decelerator, a second gear, a movement plate, a movement rod, and a sealing strip; an output shaft of the second motor is connected to the decelerator, the decelerator is connected to the second gear; the movement plate is placed on the connection plate of the fixing support and forms a preset angle with an outside edge of the connection plate; the laser radar and the cleaning structure are mounted on the movement plate, the sealing strip is mounted at a front side of the movement plate.

8. The concealed corner laser radar integration device according to claim 7, wherein the movement plate is provided with a hole, the movement rod comprises a first movement rod and second movement rod, the second movement rod is connected to the first movement rod by a preset angle; a lower part of an end of the first movement rod is provided with a convex column, the convex column is clamped with the hole; the second movement rod is arc-shaped, an outside section thereof is provided with teeth, the teeth mesh with the second gear.

9. The concealed corner laser radar integration device according to claim 1, wherein one side of the laser radar is fixed with a mirror, and the other side of the laser radar is equipped with a second wire harness, the second wire harness is configured to be connected to an autonomous driving domain controller or an advanced auxiliary driving domain controller.

10. A vehicle comprising the concealed corner laser radar integration device according to claim 1.
